(19) United States
(12) Patent Application Publication
(10) Pub. No.: US 2007/0068270 A1
(43) Pub. Date: Mar. 29, 2007

(54) Electronic gauge for measuring the maximum draw weight of a compound bow

(76) Inventors: Gary Coffey, Glendale, KY (US); Dustin P. Barmes, Vincennes, IN (US); Gregory P. Barmes, Vincennes, IN (US); Ying Chen Li, Baoan (CN)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/322,452

(22) Filed: Dec. 30, 2005

Related U.S. Application Data
(60) Provisional application No. 60/721,177, filed on Sep. 28, 2005.

(51) Int. Cl. G01B 5/30

(52) U.S. Cl. 73/760

(57) ABSTRACT

An electronic gauge for measuring the maximum draw weight of a compound bow. The gauge comprises a bow engagement member configured to receive a bowstring of a compound bow. A force sensor is operatively coupled to the bow engagement member such that axial forces applied to the bow engagement member are applied to the force sensor. The force sensor is configured to generate an electrical signal representing the draw weights applied to the bow engagement member as the compound bow is pulled through at least a portion of a draw stroke. A processor is in electrical communication with the force sensor to determine a maximum draw weight of the compound bow based on the electrical signal generated by the force sensor.

### CROSS-REFERENCE TO RELATED APPLICATIONS

This application claims priority to Provisional Application Ser. No. 60/721,177, filed on Sep. 28, 2005, the entire disclosure of which is hereby incorporated by reference.

### BACKGROUND

1. Technical Field

The present invention relates to a measuring device for use with a compound bow, and particularly to an electronic gauge for measuring the maximum draw weight of a compound bow.

2. Background Information

Compound bows have a distinctive feature: a cam and cable system located at one or both ends of the bow. This system provides what is called “let-off,” a reduction in the amount of force needed to hold the bow in the fully drawn position. This allows an archer to comfortably aim in a fully drawn position for a longer period of time than other types of bows.

FIG. 1 is a graph that represents the draw weight of a typical compound bow along the bow's draw length. The force required to draw the bow increases until reaching a maximum draw weight near the end of the draw stroke. Upon reaching the maximum draw weight, the force required to continue drawing the bow is reduced dramatically, depending upon the amount of let-off. For example, a compound bow with a 70 pound maximum draw weight and 80% let-off would require an archer to hold back only 14 pounds once the bow is fully drawn.

The maximum draw weight of compound bows is typically adjustable. An archer may adjust the maximum draw weight so that the bow can be comfortably held in fully drawn position. The maximum draw weight may also be adjusted for conditions or the type of game to be hunted. For example, an archer may adjust the maximum draw weight to account for the type and weight of arrow to be used.

Adjusting a compound bow to a desired maximum draw weight is typically an iterative process. Before making any adjustments, the maximum draw weight of the bow is measured to determine how the bow should be adjusted. After adjusting the bow, the maximum draw weight of the bow is again measured to determine the effect of the adjustment on the maximum draw weight. This process of adjusting the bow and measuring the maximum draw weight continues until a desired maximum draw weight is reached.

Although the accuracy of a compound bow may be adversely affected if the maximum draw weight is not precisely adjusted, the devices that are typically used for measuring the maximum draw weight are not precise. Hanging scales are commonly used to measure the maximum draw weight of compound bows. Hanging scales include a hooked portion attached to one end of a spring, with the other end of the spring attached to the scale's housing. The housing includes a weight indicator that moves concomitant with the movement of the spring. A series of metered markings, representing the weight in pounds and/or kilograms, are printed on the housing adjacent to the area in which the weight indicator moves. The markings are spaced such that the distance by which the weight indicator moves indicates the force that is exerted on the hooked end of the scale. To measure the maximum draw weight using such a scale, the bowstring is placed on the hooked end and the bow is pulled in a downward direction until reaching the maximum draw weight.

The use of these types of scales for measuring the maximum draw weight of a compound bow suffers from many disadvantages. For example, a user must closely monitor the position of the weight indicator on the scale to determine when the bow is at the maximum draw weight. This often leads to inaccurate results or may require that the maximum draw weight be measured several times to verify the measurement. Additionally, the precision of the measurement is limited by the user's ability to discern slight movements of the weight indicator along the metered markings. Moreover, the maximum draw weight is difficult to measure because of the dramatic reduction in force required to draw the bow during let-off. This typically causes the bow to be drawn to a position that overshoots the maximum draw weight.

Therefore, there exists a need for a device that can precisely measure the maximum draw weight of a compound bow without the aforementioned disadvantages.

### BRIEF SUMMARY

In one aspect, this invention provides an electronic gauge for measuring the maximum draw weight of a compound bow. The gauge comprises a bow engagement member configured to receive a bowstring of a compound bow. A force sensor is operatively coupled to the bow engagement member such that axial forces applied to the bow engagement member are applied to the force sensor. The force sensor is configured to generate an electrical signal representing the draw weights applied to the bow engagement member as the compound bow is pulled through at least a portion of a draw stroke. A processor is in electrical communication with the force sensor to determine a maximum draw weight of the compound bow based on the electrical signal generated by the force sensor.

In some exemplary embodiments, the gauge includes a housing that is operatively coupled to the bow engagement member. The housing may be mountable to a mounting mechanism such that the housing maintains a substantially stationary position when the compound bow is pulled through at least a portion of the draw stroke. Embodiments are contemplated in which the housing may be mountable to a mounting mechanism such that the housing is suspended above a surface. For example, the housing may include a handle configured to support the weight of the gauge and axial forces applied to the bow engagement member as the compound bow is pulled through at least a portion of the draw stroke. Often, the handle may include a curved portion for reducing lateral movement of the mounting mechanism.

In another aspect, this invention provides a method for measuring the maximum draw weight of a compound bow. One step of the method involves suspending an electronic gauge configured to measure a maximum draw weight of a compound bow above a surface. The electronic gauge may include a bow engagement member. An additional step in the method involves coupling a bowstring of a compound bow to the bow engagement-member such that axial forces applied to the bow are applied to the bow engagement member. The method also includes a step that involves pulling the compound bow through at least a portion of a draw stroke. In many cases, the compound bow may be pulled along an axis that is substantially parallel to a vertical axis.

In some exemplary embodiments, the electronic gauge may be suspended in a manner such that a longitudinal axis defined by the bow engagement member is substantially parallel to a vertical axis. Exemplary embodiments are also contemplated in which the bowstring may be coupled to the electronic gauge such that a longitudinal axis defined by the bowstring is substantially parallel to a horizontal axis.

In a further aspect, this invention provides an electronic gauge for measuring the maximum draw weight of a compound bow. The gauge comprises a bow engagement member configured to receive a bowstring of a compound bow. The bow engagement member operatively connects to a housing. Means are provided for generating an electrical signal representing draw weights applied to the bow engagement member as the compound bow is pulled through at least a portion of the draw stroke. The generating means is in electrical communication with a processor. The processor is configured to determine a maximum draw weight of the compound bow based on the electrical signal of the generating means. The processor may be in electrical communication with a display.

The processor is switchable between a first mode and a second mode. In the first mode, the processor continuously updates the display to show a currently measured draw weight based on the electrical signal of the generating means. In a second mode, the processor updates the display to show the maximum draw weight of the compound bow.

Other aspects of this invention are achieved by a method for determining the maximum draw weight of a compound bow. One step of the method involves storing a previously measured maximum draw weight in a memory. The method also includes a step that involves receiving an electrical signal representing a currently measured draw weight of a compound bow. An additional step in the method involves determining whether the currently measured draw weight is greater than the previously measured maximum draw weight. If the currently measured draw weight is greater than the previously measured maximum draw weight, the method includes a step that involves replacing the previously measured maximum draw weight with the currently measured draw weight in the memory.

Other objects, features and aspects of the present invention are achieved by various combinations and subcombinations of the disclosed elements, which are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is a graph showing the draw weight of a typical compound bow along the draw length of the compound bow;

FIG. 2 is a diagrammatical representation of various functional components of an electronic gauge according to an embodiment of the present invention;

FIG. 3 is a flow chart showing the process of obtaining the maximum draw weight of a compound bow according to an embodiment of the present invention;

FIG. 4 is a front view of an electronic gauge according to an embodiment of the present invention;

FIG. 5 is a perspective view of the electronic gauge shown in FIG. 4, with a portion cut away to show the bow engagement member and force sensor;

FIG. 6 is a schematic diagram of an example circuit constructed in accordance with the present invention; and

FIG. 7 is a front view of the gauge shown in FIG. 4 coupled to a compound bow that have been pull to end of its draw stroke.

Repeat use of reference characters in the present specification and drawings is intended to represent same or analogous features or elements of the invention.

### DETAILED DESCRIPTION OF THE DRAWINGS AND THE PRESENTLY PREFERRED EMBODIMENTS

Reference is made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For example, features illustrated or described as part of one embodiment may be used on another embodiment to yield a still further embodiment.

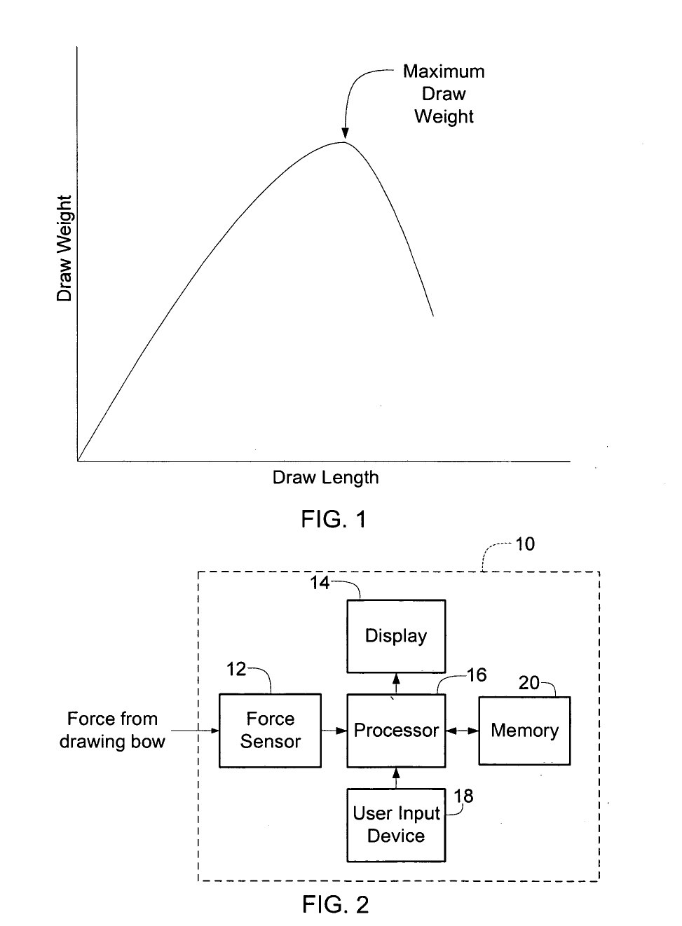

The present invention provides an electronic gauge for measuring the maximum draw weight of a compound bow. To measure the maximum draw weight, a compound bow is coupled to the gauge and pulled past the maximum draw weight portion of the compound bow's draw stroke. As shown in FIG. 1, the draw weight of a compound bow increases until reaching a maximum draw weight near the end of the draw stroke. Upon reaching the maximum draw weight, the draw weight for the remainder of the draw stroke decreases due to let-off. The gauge continuously measures the force exerted by the compound bow during the draw stroke using a force sensor. The maximum force measured by the gauge is tracked to determine the maximum draw weight of the compound bow. It should be appreciated that the draw weight curve shown in FIG. 1 is provided for purposes of example only and that the draw weight curve for a particular compound bow will be based on the specific configuration of the bow.

Referring FIG. 2, an exemplary gauge 10 for measuring the maximum draw weight of a compound bow is illustrated. In the example shown, the gauge 10 includes a force sensor 12, a display 14, a processor 16, a user input device 18 and memory 20. The gauge 10 may optionally include other features not directly related to measuring the maximum draw weight, such as a temperature sensor or wind sensor.

The force sensor 12 may generate an electrical signal in response to a force being applied to the force sensor 12. The electrical signal generated by the force sensor 12 represents the amount of force applied to the force sensor 12. For example, the electrical signal generated by the force sensor 12 may be proportional to the amount of force applied to the force sensor 12. While the force sensor 12 may be any suitable force transducer or other suitable sensor for measuring force, the force sensor 12 is preferably a load cell. The force sensor 12 may generate a single electrical signal or multiple electrical signals to represent the applied force.

The force sensor 12 may be coupled to a bow such that moving the bow through the bow's draw stroke acts as an input force that is applied to the force sensor 12. For example, the bow may be coupled to the force sensor 12 using a bow engagement member as described below. As forces are applied to the force sensor 12 by drawing the bow, the force sensor 12 may continuously generate an electrical signal representing the draw weight that is currently being applied to the bow.

The force sensor 12 is in electrical communication with the processor 16 to provide the processor 16 with the electrical signal representing the currently measured draw weight. The processor 16 may be configured to track the maximum draw weight measured by the force sensor 12. This allows the processor 16 to determine the maximum draw weight measured during the draw length of a bow.

The display 14 may be in electrical communication with the processor 16 for allowing a user to view information relating to the gauge 10. For example, the display 14 may show the maximum draw weight measured by the gauge 10. If the gauge 10 included a temperature sensor, for example, the temperature reading may be provided on the display 14. While the display 14 is preferably a character liquid crystal display (“LCD”), any other suitable display could be used. Methods for driving an LCD with particular characters are known in the art.

The user input device 18 is in electrical communication with the processor 16 for allowing a user to input commands into the gauge 10. For example, the user input device 18 may include a portion that would allow a user to switch between displaying metric units to English units of the maximum draw weight. By way of another example, the user input device 18 may include a portion for clearing the maximum draw weight measured by the gauge from memory. In other examples, the user input device 18 may include a portion for powering off the gauge 10. Embodiments are also contemplated where the user input device 18 allows the user to switch between a mode that continuously updates the display 14 with the currently measured weight and a mode that updates the display 14 to show the maximum draw weight.

The term user input device should be broadly construed to include any suitable device that would allow a user to provide an input to the gauge, such as slide switches, push buttons, keyboards, scroll wheels, touch screens or touch pads. In some examples, the user input device 18 may include multiple types of devices that would allow input from a user. For example, the user input device 18 may include both a slide switch portion and a push button portion. Moreover, the portions of the user input device 18 need not necessarily be in close proximity. For example, the user input device 18 may include a portion on the front of the gauge 10 and another portion on the back of the gauge 10.

The processor 16 is in electrical communication with memory 20. The memory 20 may be used to store data relating to the function of the gauge 10. For example, the processor 16 may store force measurements received from the force sensor 12 in the memory 20. By way of another example, the memory 20 may include data related to the calibration of the force sensor 12. While any suitable memory may be used, an EEPROM is preferably used.

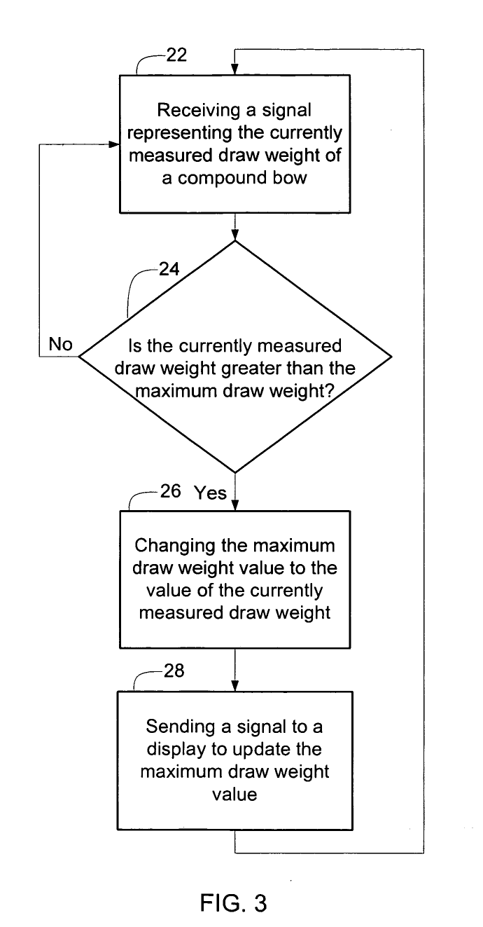

Upon coupling the bow to the force sensor 12, the bow may be pulled through the draw stroke. As the bow starts to move through the draw stroke, the force sensor 12 will detect the force being applied to the force sensor 12. As shown in step 22 of FIG. 3, the processor 16 receives a signal from the force sensor 12 that represents the currently measured draw weight of the compound bow. The processor 16 will then determine whether the currently measured draw weight is greater than the maximum draw weight, as shown in step 24. If the currently measured draw weight is greater than the maximum draw weight, the value of the maximum draw weight is changed to the value of the currently measured draw weight as shown in step 26. The processor 16 may send a signal to the display 14 to show the new value of the new maximum draw weight, as shown in step 28.

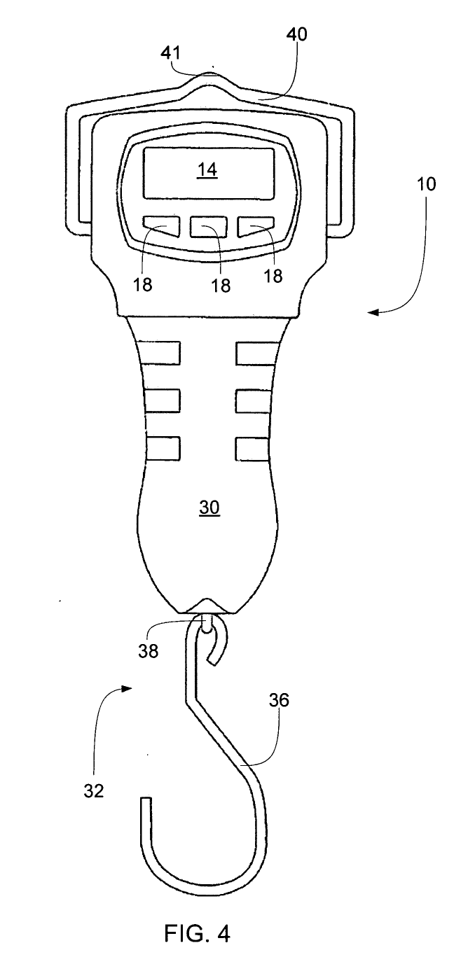

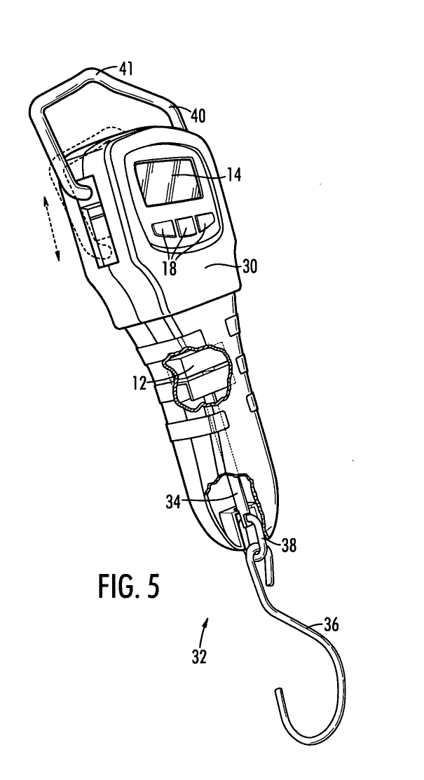

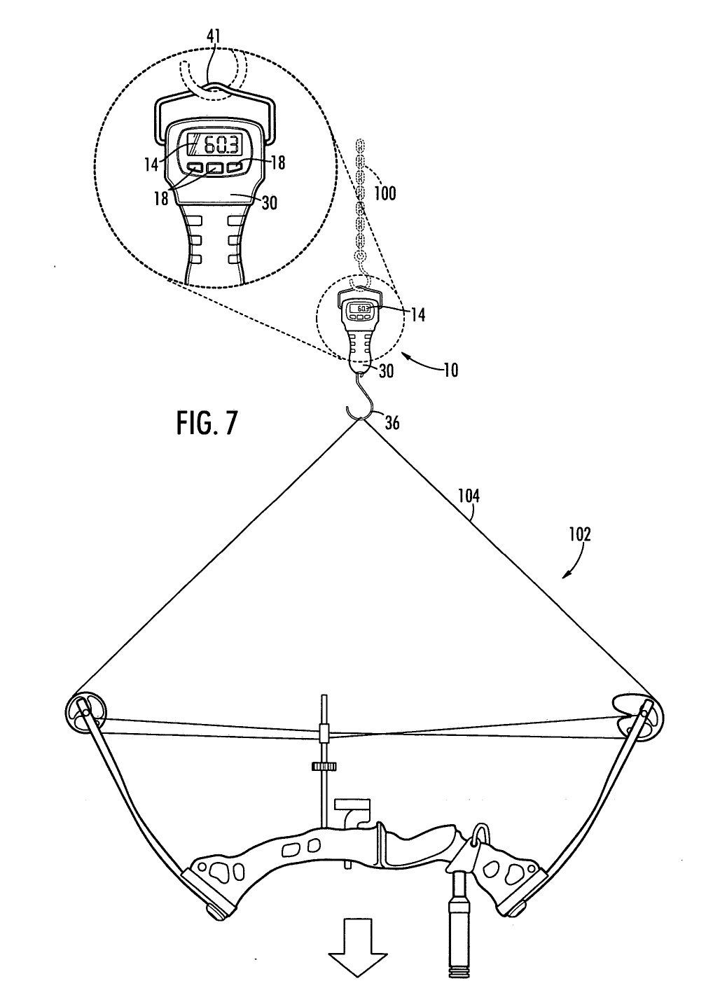

Referring now to FIGS. 4 and 5, a gauge constructed in accordance with the invention is shown. The gauge 10 includes a housing 30 in which the gauge's electronics are contained, a display 14, a user input device 18, and a bow engagement member 32 for coupling the bow to the force sensor 12. The bow engagement member 32 is configured to receive a bowstring 104 of a compound bow 102 such that axial forces applied to the bow engagement member 32 are applied to the force sensor 12 as the bow is pulled through at least a portion of a draw stroke (See FIG. 7). In the embodiment shown, the bow engagement member 32 includes a rod 34 having a proximal end depending from the force sensor 12 and a distal end with a hook portion 36 to facilitate engagement of the bow's bowstring 104. As shown, the hook portion 36 is pivotally connected to the rod 34 using a link 38. However, the hook portion 36 may be attached to the rod 34 in a fixed position. The rod 34 and the hook portion 36 may be formed as separate pieces that are coupled together or as a unitary member.

In the example shown, the housing 30 is configured as a hanging scale with a handle 40 that allows the housing 30 to be suspended from a wall, ceiling or other surface using a mounting mechanism 100 (See FIG. 7). With the housing 30 mounted in this manner, the housing 30 may maintain a substantially stationary position when the compound bow is pulled through at least a portion of the draw stroke. In some examples, the handle 40 may be moved between an extended and retracted position (see FIG. 5). In the retracted position, the handle 40 is proximally adjacent to the housing 30. In the extended position, the handle 40 is extended away from the housing 30. In some examples, the handle 40 may include a curved portion 41 to prevent lateral movement of the handle with respect to said mounting mechanism 100. It should be appreciated that other means may be provided for mounting the gauge 10 in a stationary position.

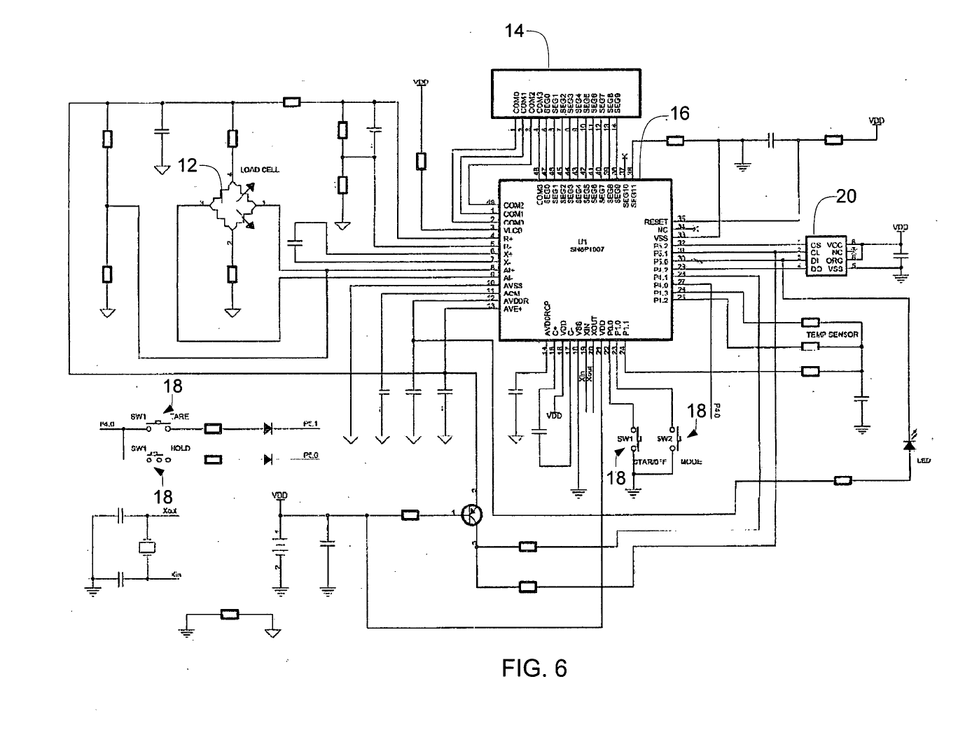

FIG. 6 shows an example circuit in accordance with the invention. In this example, the circuit includes a force sensor 12 electrically connected as an input to a processor 16. The circuit includes memory 20 that may be read by and/or written to by the processor 16. The visual display 14 is in electrical communication as an output of the processor 16. In the example shown, the visual display 14 is an LCD display.

In the example shown, the force sensor 12 is a load cell with several inputs connected to the processor 16. The load cell will have a certain level of distortion when a load is applied to the load cell. This leads to a variable voltage output by the load cell based on the weight of the input load. The load cell may be associated with resistors and capacitors to convert the output of the load cell to digital voltage levels (i.e., 5.0 or 3.3 volts). The processor 16 may include an analog to digital converter to aid in the conversion from the analog output of the load cell. The circuit configuration with respect to the load cell shown in FIG. 6 is provided for example purposes only. Other suitable interfaces may be provided between the output of the force sensor 12 and processor 16. The processor 16 interacts with calibration data stored in memory 20 to determine a currently measured draw weight based on the output of the force sensor 12.

The circuit may include a user input device 18. As shown, the user input device 18 includes a switch (SW1) that allows the user to control whether the maximum draw weight or currently measured draw weight is shown on the visual display 14. If the user selects the mode that displays the currently measured draw weight, the processor continuously updates the visual display with the currently measured weight. If the user wants to measure the weight of a deer, for example, the user may select the mode that displays the currently measured weight. In this mode, the weight of the deer would be displayed to the user like a typical scale. The user may switch to display the maximum draw weight if the maximum draw weight of a compound bow is desired to the measured. The switch (SW1) may also be configured to clear the visual display 14. For example, after the user has measured the maximum draw weight of a compound bow, the visual display 14 may be reset to zero before the gauge 10 is used to measure the maximum draw weight of another bow. The switch (SW1) may also be configured to power up and turn off the gauge 10. The user input device 18 may also include a switch (SW2). This switch (SW2) may be configured to cycle the processor 16 through different modes. For example, the switch may be used to cycle between displaying English units and metric units on the visual display 14.

In operation, referring to FIG. 7, the gauge 10 may be mounted to a mounting mechanism 100. In the example shown, a proximal end of the mounting mechanism 100 may be connected to a stationary object (not shown), such as a wall or ceiling. The distal end of the mounting mechanism may include a portion that may be coupled to the handle 40 of the housing 30. In the example shown, a curved portion 41 of the handle 40 is coupled with the distal end of the mounting mechanism 100 to prevent lateral movement of the handle 40.

The gauge 10 may be turned on by selecting a portion of the user input device 18. A bowstring 104 of a bow 102 is coupled to the bow engagement member 32. In the example shown, the bow's bowstring 104 is placed on the hook portion 36 of the gauge 10. Forces are generated on the force sensor 12 as the bow is pulled through the bow's draw stroke. However, the gauge 10 remains in a relatively stationary position. These forces are detected by the force sensor 12, which generates a signal representing the amount of force applied to the force sensor 12. This signal is received as an input to the processor 16. The processor 16 may determine whether the current amount of force measured by the force sensor 12 is greater than the value of the maximum draw weight. If the current amount of force is greater than the value stored as the maximum draw weight, the processor 16 will update the value of the maximum draw weight with the value of the current amount of force being measured. The processor 16 may send a signal to the visual display 14 to show the new value of the maximum draw weight. In the example shown, the gauge measured a maximum draw weight of 60.3 pounds.

The present invention, therefore, provides an electronic gauge for measuring the maximum draw weight of a compound bow that is simple to operate and produces accurate results. Moreover, the gauge does not require continuous and close monitoring by a user during operation.

It is therefore intended that the foregoing detailed description be regarded as illustrative rather than limiting, and that it be understood that it is the following claims, including all equivalents, that are intended to define the spirit and scope of this invention.

We claim:

1. An electronic gauge for measuring the maximum draw weight of a compound bow, said gauge comprising:
a bow engagement member configured to receive a bowstring of a compound bow;
a force sensor operatively coupled to said bow engagement member such that axial forces applied to said bow engagement member are applied to said force sensor, said force sensor configured to generate an electrical signal representing draw weights applied to said bow engagement member as said compound bow is pulled through at least a portion of a draw stroke; and
a processor in electrical communication with said force sensor, said processor configured to determine a maximum draw weight of said compound bow based on said electrical signal.

2. The gauge as recited in claim 1, further comprising a housing operatively coupled to said bow engagement member, wherein said housing is mountable to a mounting mechanism such that said housing maintains a substantially stationary position when said compound bow is pulled through at least a portion of said draw stroke.

3. The gauge as recited in claim 2, wherein said housing is configured to be mounted such that a longitudinal axis defined by said bow engagement member is substantially parallel to a vertical axis.

4. The gauge as recited in claim 3, wherein said bow engagement member is configured to receive said bowstring such that a longitudinal axis defined by said bowstring is substantially parallel to a horizontal axis.

5. The gauge as recited in claim 1, further comprising a housing operatively coupled to said bow engagement member, wherein said housing is mountable to a mounting mechanism such that said housing is suspended above a surface.

6. The gauge as recited in claim 5, wherein said housing includes a handle configured to support the weight of said gauge and axial forces applied to said bow engagement member as said compound bow is pulled through at least a portion of said draw stroke.

7. The gauge as recited in claim 6, wherein said handle is configured to support a weight that is greater than said maximum draw weight.

8. The gauge as recited in claim 6, wherein said handle includes a curved portion for reducing lateral movement of said handle with respect to said mounting mechanism.

9. The gauge as recited in claim 6, wherein said handle has a U-shape.

10. The gauge as recited in claim 2, wherein said housing includes a portion capable of being hand-held.

11. The gauge as recited in claim 1, wherein said bow engagement member includes a hook-shaped portion.

12. The gauge as recited in claim 11, wherein said bow engagement member includes a rod operatively coupled between said hook-shaped portion and said force sensor.

13. The gauge as recited in claim 1, wherein said force sensor is a load cell.

14. The gauge as recited in claim 1, further comprising a display in electrical communication with said processor, said display configured to show said maximum draw weight.

15. An electronic gauge for measuring the maximum draw weight of a compound bow, said gauge comprising:
a bow engagement member configured to receive a bowstring of a compound bow;
a housing operatively connected to said bow engagement member;
means for generating an electrical signal representing draw weights applied to said bow engagement member as said compound bow is pulled through at least a portion of said draw stroke;
a processor in electrical communication with said generating means, said processor configured to determine a maximum draw weight of said compound bow based on said electrical signal; and
a display in electrical communication with said processor, and wherein said processor is switchable between a first mode in which said processor continuously updates said display to show a currently measured draw weight based on said electrical signal and a second mode in which said processor updates said display to show said maximum draw weight.

16. The gauge as recited in claim 15, wherein said housing is mountable such that said housing is suspended above a surface.

17. The gauge as recited in claim 16, wherein said housing is configured to be mounted such that a longitudinal axis defined by said bow engagement member is substantially parallel to a vertical axis.

18. The gauge as recited in claim 15, wherein said housing includes means for supporting the weight of said gauge and axial forces applied to said bow engagement member as said compound bow is pulled through at least a portion of said draw stroke.

19. The gauge as recited in claim 15, wherein said bow engagement member is configured to receive said bowstring such that a longitudinal axis defined by said bowstring is substantially parallel to a horizontal axis.

20. The gauge as recited in claim 15, wherein said generating means is configured to generate an electrical signal representing draw weights greater than 30 pounds.

21. The gauge as recited in claim 15, further comprising means for measuring an ambient temperature proximate to said bow engagement member.

22. A method for measuring the maximum draw weight of a compound bow, said method comprising:
suspending an electronic gauge configured to measure a maximum draw weight of a compound bow above a surface, said electronic gauge including a bow engagement member;
coupling a bowstring of a compound bow to said bow engagement member such that axial forces applied to said bow are applied to said bow engagement member; and
pulling said compound bow through at least a portion of a draw stroke.

23. The method as recited in claim 22, wherein in said suspending step, said electronic gauge is suspended in a manner such that a longitudinal axis defined by said bow engagement member is substantially parallel to a vertical axis.

24. The method as recited in claim 22, wherein in said coupling step, said bowstring is coupled to said electronic gauge such that a longitudinal axis defined by said bowstring is substantially parallel to a horizontal axis.

25. The method as recited in claim 22, wherein in said pulling step, said compound bow is pulled along an axis that is substantially parallel to a vertical axis.

26. A method for determining the maximum draw weight of a compound bow, said method comprising:
storing a previously measured maximum draw weight in a memory;
receiving an electrical signal representing a currently measured draw weight of a compound bow;
determining whether said currently measured draw weight is greater than said previously measured maximum draw weight; and
if said currently measured draw weight is greater than said previously measured maximum draw weight, replacing said previously measured maximum draw weight with said currently measured draw weight in said memory.
